(19) United States
(12) Patent Application Publication
(10) Pub. No.: US 2008/0095144 A1
(43) Pub. Date: Apr. 24, 2008

(54) Providing service availability despite bandwidth limitations

(75) Inventor: H. Jeff Goldberg, Lakewood, NJ (US)

Correspondence Address: DAVIDSON BERQUIST JACKSON & GOWDEY LLP, 4300 WILSON BLVD., 7TH FLOOR, ARLINGTON, VA, 22203, US

(73) Assignee: NET2PHONE, INC., Newark, NJ (US)

(21) Appl. No.: 11/584,641

(22) Filed: Oct. 23, 2006

(51) Int. Cl. H04L 12/66

(52) U.S. Cl. 370/352; 370/401

(57) ABSTRACT

A bandwidth manager includes a bandwidth monitor for monitoring the available bandwidth of plural routes within the corresponding network. At least one primary, higher bandwidth link (HBL), and at least one secondary, lower bandwidth link (LBL) are monitored by the bandwidth monitor. When the bandwidth monitor determines that the primary, higher bandwidth link is experiencing a failure or a degradation in bandwidth (e.g., the link is performing at less than a threshold bandwidth), the bandwidth monitor notifies a call filter of the failure or degradation. In response, the call filter can deny additional voice channel requests unless the requests are for higher priority calls (e.g., calls to or from emergency services or emergency service answering points).

### CROSS-REFERENCE TO CO-PENDING APPLICATIONS

### Field of Invention

The present application is directed to the field of call routing under changing bandwidth constraints, and in one embodiment to the field of call filtering and routing in order to be able to increase the likelihood of providing higher priority calls under conditions of low bandwidth.

### DISCUSSION OF THE BACKGROUND

Telephony services include both circuit switched technology (e.g., the public switched telephone network (PSTN)) and packet-switched technology (e.g., voice-over-IP (VoIP)). VoIP solutions often utilize an architecture, such as in FIG. 1, where a softswitch and at least one media gateway are located in a centralized location, while the endpoints being served are distributed throughout various networks. However, such a configuration can lead to voice quality and availability issues in the presence of constrained or reduced bandwidth. Such availability issues may be extremely important when a consumer expects emergency services (e.g., 911) to be available at all times.

As shown in FIG. 1, the signaling packets may, and often are, carried along different paths from that of the voice packets. In one such configuration, signaling packets go between a client (e.g., a packet-enabled telephone) and the softswitch, while voice goes between the client and the media gateway.

As shown in FIG. 2, the internals of a packet network between a client and the softswitch/media gateway is not typically known by the user of the client (and are therefore indicated by block arrows and a cloud). Instead, the client simply assumes that there exists at least one path between at least one router close to the client (i.e., the client-side router(s)) and at least one router close to the softswitch/media gateway (i.e., the switch-side router(s)). The number of paths between the client-side router(s) and the switch-side router(s) may vary from point to point, and is controlled by a network designer and may be affected by the dynamic (un)availability of certain links along the way.

As shown in FIG. 3, in some implementations of a packet network, there may be a number of redundant links going between the client-side router(s) and the switch-side router(s) or at least between some points in between the client-side router(s) and the switch-side router(s). In some such cases, one of the links may be a primary, higher bandwidth link (HBL), and another may be a secondary, lower bandwidth link (LBL). In such a configuration, if all calls were allowed to be sent over the secondary, lower bandwidth link during a failure of the primary, higher bandwidth link, then the secondary, lower bandwidth link could become overloaded and unable to carry a higher priority call, such as an emergency services call (e.g., a call to 911).

### BRIEF DESCRIPTION OF THE DRAWINGS

The following description, given with respect to the attached drawings, may be better understood with reference to the non-limiting examples of the drawings, wherein:

FIG. 1 is a network diagram of a known centralized VoIP configuration where the softswitch and the media gateway are remotely located from clients of plural networks;

FIG. 2 is a network diagram of a generalized communications path between at least one client-side router near clients (e.g., IP phones) and at least one switch-side router near the softswitch and/or the media gateway;

FIG. 3 is a network diagram of a generalized communications path between at least one client-side router near clients (e.g., IP phones) and at least one switch-side router near the softswitch and/or the media gateway that includes a primary, higher bandwidth link and a secondary), lower bandwidth link;

FIG. 4 is a network diagram of a centralized VoIP configuration where a bandwidth manager is included on a switch-side and interposed between (1) the softswitch and the media gateway and (2) clients of plural networks;

FIG. 5 is a generalized diagram of the internal configuration of one embodiment of a bandwidth manager as shown in FIG. 4;

FIG. 6 is a network diagram of a centralized VoIP configuration where a bandwidth manager is included on a client-side and interposed between (1) the softswitch and the media gateway and (2) clients of plural networks; and

FIG. 7 is a network diagram of a centralized VoIP configuration where a bandwidth manager is included on a switch-side and interposed between (1) the softswitch and the media gateway and (2) clients of plural networks where a softswitch controls more than one media gateway.

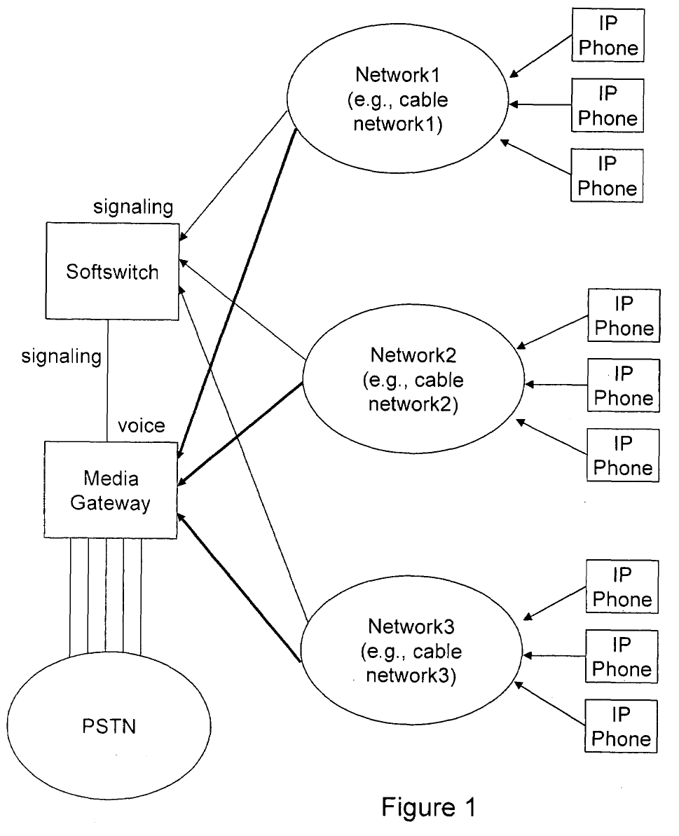

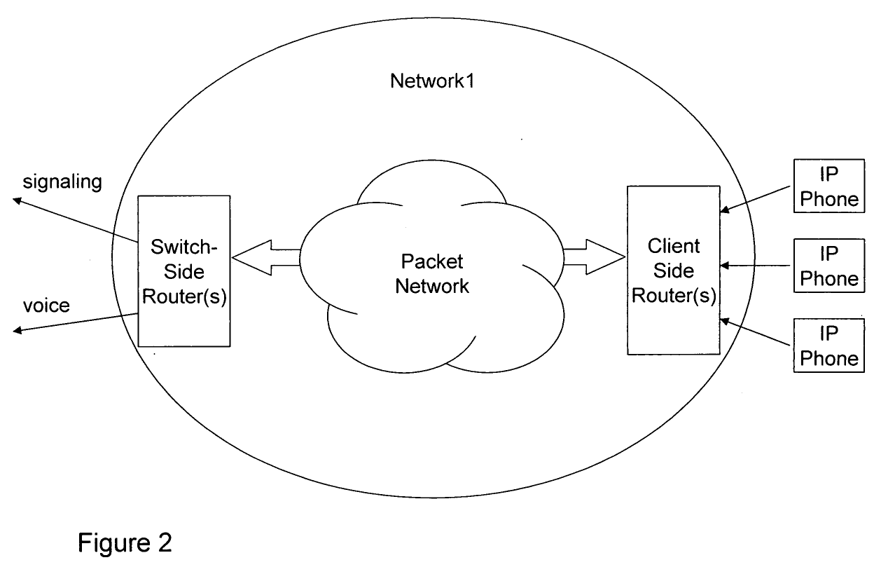

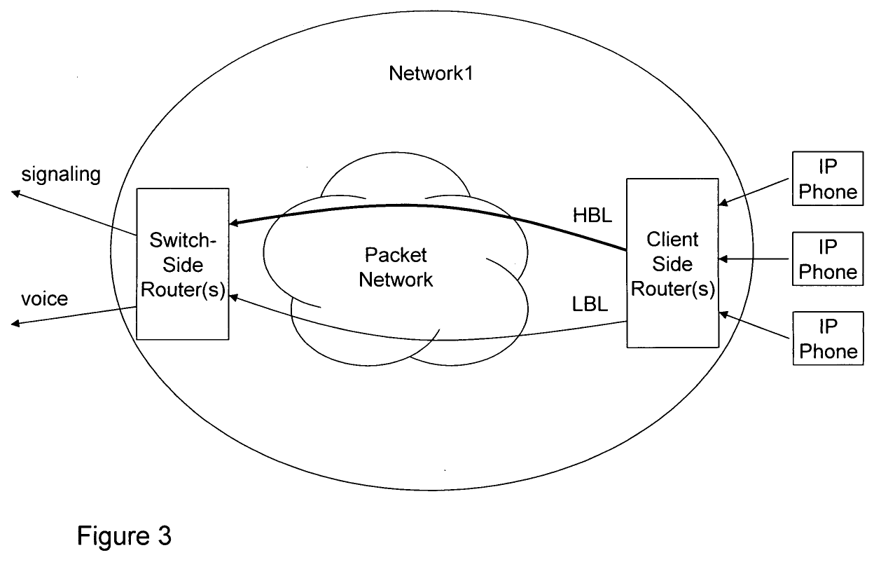

### DISCUSSION OF THE PREFERRED EMBODIMENTS

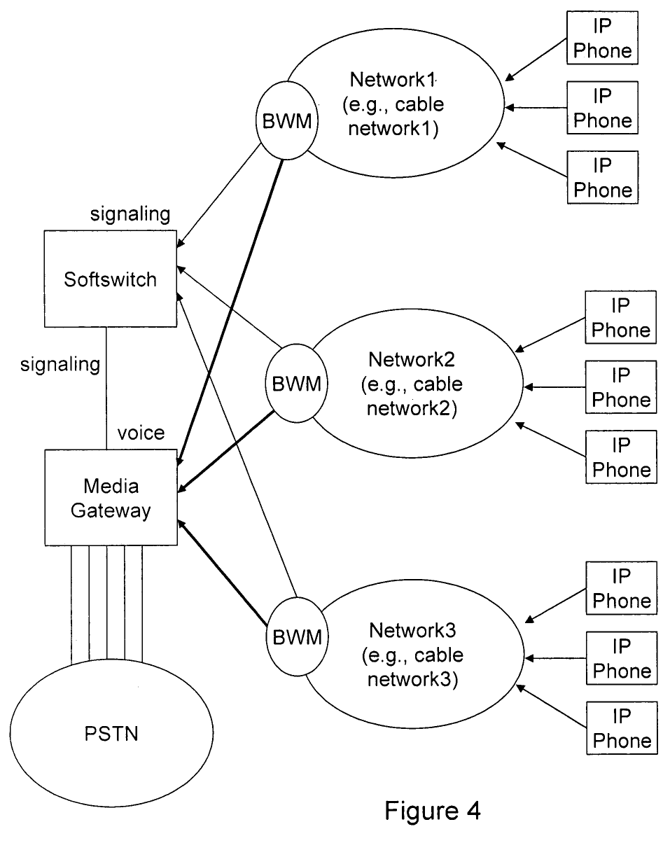

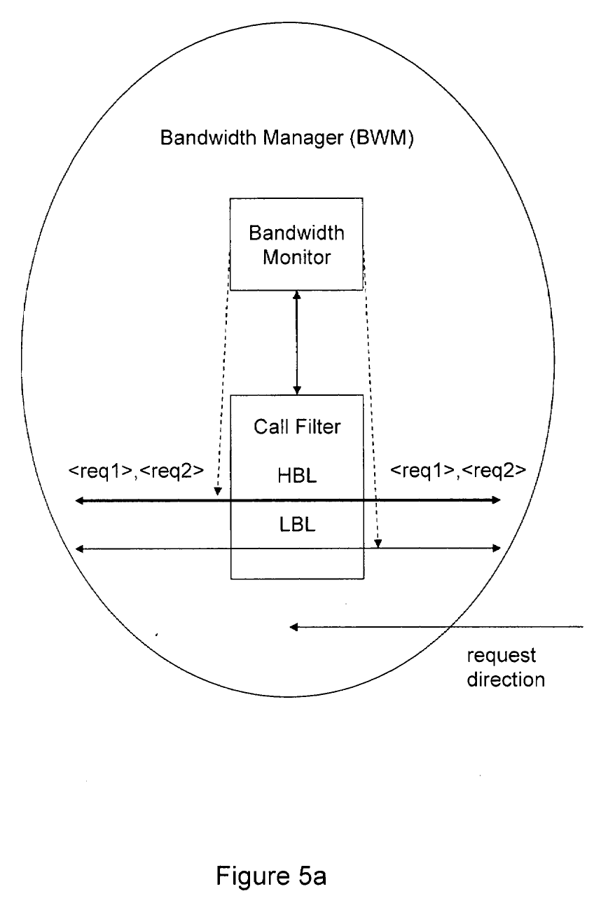

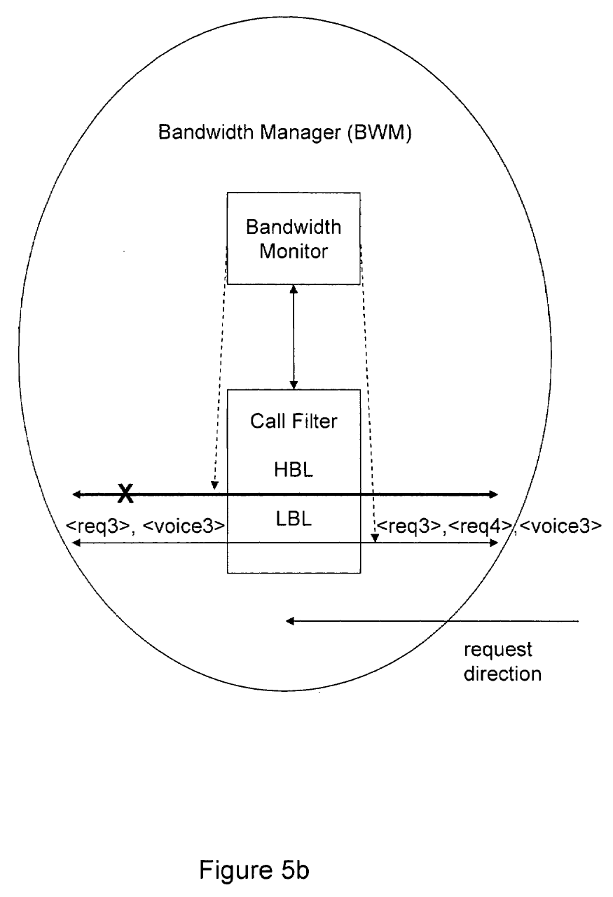

FIG. 4 illustrates an environment where plural networks each support at least one telephony client (e.g., (1) an IP-based phone such as a WiFi or Ethernet-based phone, (2) a conventional phone connected to a VoIP adapter such as the family of Multimedia Terminal Adapters made by Innomedia or (3) a computer-based telephony client such as a program receiving microphone input of a computer that also plays out received voice signals via speakers or a headset). The illustrated networks connect to a common back-end (e.g., (a) at least one softswitch for managing call control and (b) at least one media gateway connected to a telephony system (e.g., the public switched telephone network (PSTN)). In such an embodiment, each of the networks is preferably connected to a corresponding bandwidth manager, such as is shown in FIGS. 5a and 5b.

The bandwidth manager includes a bandwidth monitor for monitoring the available bandwidth of plural routes within the corresponding network. As illustrated, a primary, higher bandwidth link (HBL), and a secondary, lower bandwidth link (LBL) are monitored by the bandwidth monitor. When the bandwidth monitor determines that the primary, higher bandwidth link is experiencing a failure or a degradation in bandwidth (e.g., the link is performing at less than a threshold bandwidth), the bandwidth monitor notifies a call filter of the failure or degradation. In response, the call filter can deny additional voice channel requests unless the requests are for higher priority calls (e.g., calls to or from emergency services or emergency service answering points).

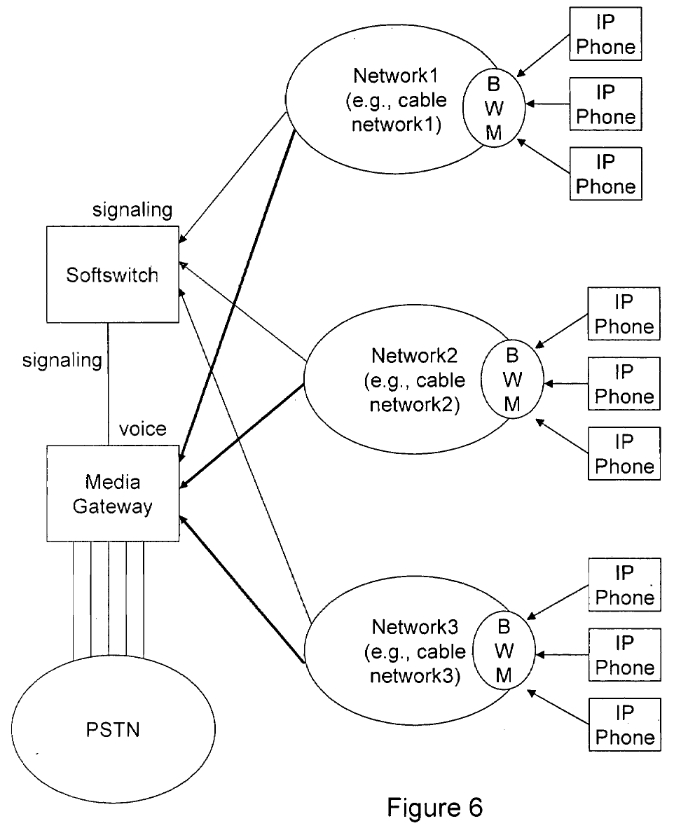

In the embodiments of FIGS. 4 and 6, a single bandwidth manager is assigned each corresponding network that is to have managed bandwidth. In the embodiment of FIG. 4, the respective bandwidth managers are located on the switch-side near the telephony backend. In the embodiment of FIG. 6, the respective bandwidth managers are located on the client-side near the telephony clients that make requests of the telephony backend. In an alternate embodiment, some of the bandwidth managers are located on the switch-side near the telephony backend while others are located on the client-side. In yet another embodiment, at least some portion (e.g., a call filter) of a bandwidth manager may be shared between several networks.

Returning to FIGS. 5a and 5b, a bandwidth manager, such as the bandwidth manager of FIGS. 4 and 6, is shown in greater detail. In FIG. 5a, a bandwidth manager receives a series of requests from at least one telephony client. When the first and second requests (labeled <req1> and <req2>) are received, the bandwidth monitor has not yet detected any degradation or failure in the high bandwidth link. Thus, the first and second requests are forwarded on to their corresponding softswitch (which may be the same softswitch or different softswitches).

Later, as shown in FIG. 5b, the bandwidth monitor has detected a degradation or failure in a high bandwidth link and has notified the Call Filter. Accordingly, the Call Filter begins to prioritize the voice call traffic that is allowed to pass on the low bandwidth link. As illustrated, the call filter determines that a third request (labeled <req3>) is a high priority request (e.g. a request for emergency services) and allows the request to pass to the softswitch. On the other hand, the call filter determines that a fourth request (labeled <req4>) is not a high priority request (e.g., is not a request for emergency services) and does not allow the request to pass to the softswitch. In one embodiment, the call filter returns to the requesting telephony client an error code that causes the telephony client to notify the caller that a call cannot be completed at this time. The telephony client may signal the caller of this condition in a number of ways, such as playing a fast busy signal or a prerecorded message. Alternatively, the telephony client's request may be passed on from the Call Filter to another specialized softswitch that is designed to directly play a voice message announcing the failure and then disconnect.

As illustrated in FIG. 5b, the voice for the third request (labeled <voice3>) is allowed to pass on the low bandwidth link (LBL). Because the Call Filter prioritizes the call requests that are allowed to pass to the softswitch, the telephony clients do not begin lower priority voice calls (which consume significantly higher bandwidth than the call connection requests), and a sufficient amount of bandwidth can be retained on the lower priority link to support higher priority calls (e.g., calls to emergency services). Moreover, since this call control can be performed on a network-by-network basis by interposing a bandwidth manager between the telephony backend and the telephony client, a single, shared softswitch can support multiple higher priority calls without having to be programmed to know the network configuration. Similarly, a single Call Filter can be used to perform prioritization for plural softswitches.

In an alternate embodiment, additional levels of similar or different bandwidth links may be monitored by a bandwidth monitor (rather than just the two levels depicted in FIGS. 5a and 5b).to enable various intermediate levels of service as various links experience failure, congestion or other bandwidth limiting issues.

A bandwidth manager can be interposed between a telephony client and a telephony backend in a number of ways. First, the telephony clients can be configured to make all call connection requests to the Call Filter directly. For example, instead of configuring a telephony client to request call connections via the softswitch at softswitch.sharedsoftswitch.com, the telephony client instead is configured to request call connections via the Call Filter at callfilter.localnetwork1.com. (It is anticipated that with good programming practices, the configuration can be done by storing the name of the Call Filter in a configuration file internal to the telephony client rather than requiring reprogramming of the telephony client. However, the storing of the name may be done through reprogramming as well. e.g., by updating flash memory.)

When the bandwidth monitor determines that the higher bandwidth link is not experiencing a failure or degradation, the Call Filter (at callfilter.localnetwork1.com) passes the call request on to the softswitch (at softswitch.sharedsoftswitch.com) and provides any responses to the telephony client. When the bandwidth monitor determines that the higher bandwidth link is experiencing a failure or degradation and the call request is for a higher priority call, the Call Filter passes the call request on to softswitch.sharedsoftswitch.com and provides any responses to the telephony client. However, when the bandwidth monitor determines that the higher bandwidth link is experiencing a failure or degradation and the call request is not for a higher priority call, the Call Filter blocks the call request from being sent on to the softswitch and instead notifies the telephony client of the unavailability, as described above. In such an embodiment, the Call Filter is designed and programmed to be able to understand the format of the call request sufficiently well to be able to determine whether or not the call request is for a higher priority call. For example, the Call Filter may be programmed to understand SIP, MGCP or other protocols in sufficient detail to know where the telephone number is stored in the request, and the telephone number would then be compared against a list of higher priority numbers to determine if a match exists.

A second method of interposing the bandwidth manager between a telephony client and a telephony backend is to intercept DNS inquiries. In such a case, if a telephony client has been configured to request call connections via the softswitch at softswitch.sharedsoftswitch.com, the Call Filter receives the DNS inquiry to convert the name softswitch.sharedsoftswitch.com into an Internet address. In response, instead of providing the telephony client with the IP address of softswitch.sharedsoftswitch.com, the Call Filter provides the telephony client with the IP address of the Call Filter at callfilter.localnetwork1.com. Like in the first method, when the bandwidth monitor determines that the higher bandwidth link is not experiencing a failure or degradation, the Call Filter passes the call request on to softswitch.sharedsoftswitch.com and provides any responses to the telephony client. When the bandwidth monitor determines that the higher bandwidth link is experiencing a failure or degradation, the Call Filter passes or blocks the call request depending on whether or not the call request is for a higher priority call. In such an embodiment, the Call Filter is designed and programmed to be able to understand the format of the call request sufficiently well to be able to determine whether or not the call request is for a higher priority call.

A third method of interposing the bandwidth manager between a telephony client and a telephony backend is to intercept packets for known IP addresses. In such a case, if a telephony client has been configured to request call connections via the softswitch at softswitch.sharedsoftswitch.com, the Call Filter uses a DNS inquiry to convert the name softswitch.sharedsoftswitch.com into an Internet address and begins examining packets for that IP address. Like in the first and second methods, when the bandwidth monitor determines that the higher bandwidth link is not experiencing a failure or degradation, the Call Filter passes the call request on to monitored IP address of softswitch.sharedsoftswitch.com and provides any responses to the telephony client. When the bandwidth monitor determines that the higher bandwidth link is experiencing a failure or degradation, the Call Filter passes or blocks the call request depending on whether or not the call request is for a higher priority call. In such an embodiment, the Call Filter is designed and programmed to be able to understand the format of the call request sufficiently well to be able to determine whether or not the call request is for a higher priority call.

The list of higher priority numbers may be a global list (i.e., the same for all telephony clients) or a client-specific list of higher priority telephone numbers (either PSTN-style telephone numbers or IP-address style telephone numbers) matched to telephony client identifiers such that the same telephone number may be a high priority call for some telephony clients but not others, or a combination of both such that the client-specific list if checked first and if there is no match then the global list is checked. Either the global list or the client-specific list (or both) may further include times-of-day or time ranges in which the call blocking or call passing should occur. Furthermore, the list of high priority numbers may be stored either locally or remotely, and in one embodiment queries are made to a remote server to determine if a number is a high priority number.

While the above discussion has focused on requests coming from the telephony clients and going to the back-end, requests can be controlled in the opposite direction as well. Thus, FIGS. 5a and 5b are intended to be general by simply referring to “request direction” which can either be to or from the back-end. In an embodiment where the Call Filter filters requests from the back-end to the telephony clients, either the global list or the client-specific list (or both) may include at least one access control list from a softswitch to a telephony client. For example, emergency services or an emergency services access point may need to reach a telephony client, so the Call Filter may be designed to filter out any connection attempts from the softswitch to telephony clients that are not for higher priority calls such as from emergency services or an emergency services access point. In this way, lower priority calls may be blocked or refused by the Call Filter in order to reserve bandwidth for one or more higher priority calls (e.g., an emergency services call), should it come in.

In addition to or instead of filtering in the telephony protocols described above, it is also possible for the Filter to be configured to filter other requests other than telephony requests. For example, connections to specific IP addresses or server names and/or connections to specific services/ports at specific IP addresses or server names can be filtered or redirected as well. In one such embodiment, a bandwidth manager detects a request for an HTTP port connection at a known address. Because a network administrator is trying to reduce bandwidth on the network (e.g., when the bandwidth monitor determines there is congestion), the filter begins filtering out requests by specified criteria (e.g., by site name or by request type such as videos which are known to consume bandwidth). Thus, the filter is programmed to know a sufficient amount of information about the protocol being filtered to know where the relevant protocol-specific field is (e.g., where the site address or URL name is in an HTTP request).

The filter (like the Call Filter) may additionally be configured to perform filtering based on times-of-day such that bandwidth is controlled to avoid congestion (e.g., by limiting sites or types of content during peak hours).

In addition to the above, call filtering may also be performed by configuring the telephony clients themselves with a list of higher priority numbers (or lower priority numbers) that should be treated differently than numbers not on the list. For example, the telephony clients may be programmed to check an internal list and, if the number to be called is on the list, then the client connects to a corresponding softswitch without needing further filtering. In this way, a telephony client need not connect to the Call Filter when trying to reach higher priority numbers (e.g., emergency services) and instead will connect to the softswitch directly. However, when the number is not on the list, then the telephony client is programmed to connect to the Call Filter instead. The Call Filter can then, as described above, either accept or reject the call request depending on the status of the available connections.

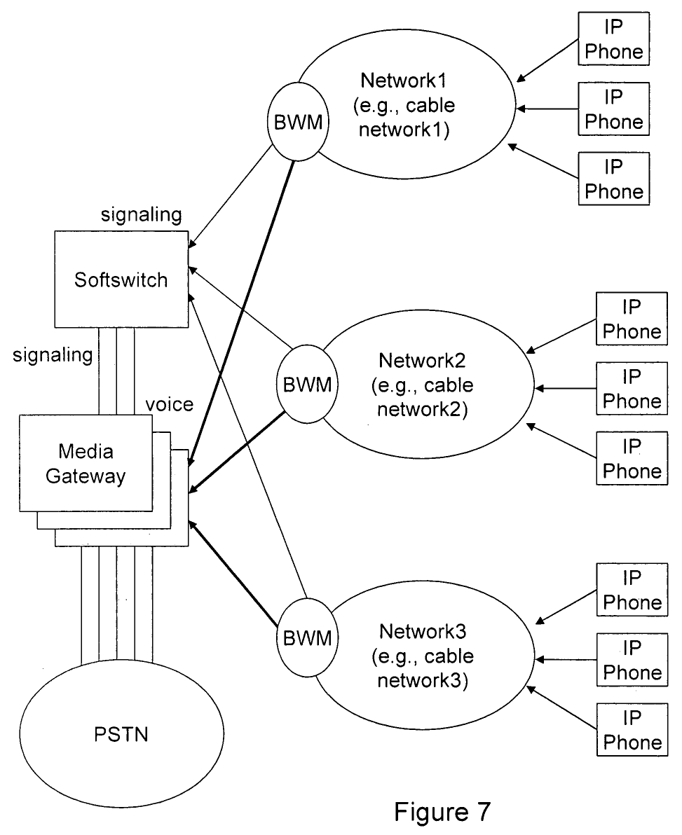

In the embodiment of FIG. 7, a bandwidth manager is included on a switch-side and interposed between (1) the softswitch and the media gateway and (2) clients of plural networks. However, in FIG. 7, a softswitch controls more than one media gateway.

Furthermore, although the above description has been given with respect to centralized media gateways at a single physical or logical location, the method of the present invention is also possible with distributed media gateways as well, where connections to those locations are independently “bandwidth monitored.”

While certain configurations of structures have been illustrated for the purposes of presenting the basic structures of the present invention, one of ordinary skill in the art will appreciate that other variations are possible which would still fall within the scope of the appended claims.

1. A method for selectively controlling utilization of packet-based voice services in a multi-route network, comprising:
determining if a higher bandwidth communications link is performing at lower than a particular threshold;
receiving a call connection request between a telephony client and a softswitch;
passing the call connection request on to the softswitch if the higher bandwidth communications link is not performing at lower than a particular threshold;
determining if the call connection request is for a high priority call;
passing the call connection request on to the softswitch if the higher bandwidth communications link is performing at lower than a particular threshold but the call connection request is for a high priority call; and
rejecting the call connection request if the higher bandwidth communications link is performing at lower than a particular threshold and the call connection request is not for a high priority call.

2. The method as claimed in claim 1, wherein the step of receiving the call connection request between the telephony client and the softswitch comprises intercepting a DNS request for the IP address of the softswitch.

3. The method as claimed in claim 1, wherein the step of receiving the call connection request between the telephony client and the softswitch comprises intercepting an IP packet destined for the IP address of the softswitch.

4. The method as claimed in claim 1, wherein the step of receiving the call connection request between the telephony client and the softswitch comprises receiving a connection request addressed to a call filter at the call filter.

5. The method as claimed in claim 1, wherein the method is performed by a bandwidth manager on a side of a network closest to the softswitch.

6. The method as claimed in claim 1, wherein the method is performed by a bandwidth manager on a side of a network closest to the telephony client.

7. The method as claimed in claim 1, wherein the step of determining if the call connection request is for a high priority call comprises determining that the call request is for a high priority call if the call request is for emergency services.

8. The method as claimed in claim 1, wherein the step of determining if the call connection request is for a high priority call comprises determining that the call request is for a high priority call if the call request is for 911.

9. The method as claimed in claim 1, wherein the step of determining if the call connection request is for a high priority call comprises determining a call origination location and a call destination.

10. The method as claimed in claim 1, wherein the step of determining if the call connection request is for a high priority call comprises determining a call origination location, a call destination and a time of day.

11. A bandwidth manager implemented as computer program instructions in a computer memory to selectively control utilization of packet-based voice services in a multi-route network, the computer program instructions in the computer memory causing the bandwidth manager to perform the steps of:
determining if a higher bandwidth communications link is performing at lower than a particular threshold;
receiving a call connection request between a telephony client and a softswitch;
passing the call connection request on to the softswitch if the higher bandwidth communications link is not performing at lower than a particular threshold;
determining if the call connection request is for a high priority call;
passing the call connection request on to the softswitch if the higher bandwidth communications link is performing at lower than a particular threshold but the call connection request is for a high priority call; and
rejecting the call connection request if the higher bandwidth communications link is performing at lower than a particular threshold and the call connection request is not for a high priority call.

12. The bandwidth manager as claimed in claim 11, wherein the step of receiving the call connection request between the telephony client and the softswitch comprises intercepting a DNS request for the IP address of the softswitch.

13. The bandwidth manager as claimed in claim 11, wherein the step of receiving the call connection request between the telephony client and the softswitch comprises intercepting an IP packet destined for the IP address of the softswitch.

14. The bandwidth manager as claimed in claim 11, wherein the step of receiving the call connection request between the telephony client and the softswitch comprises receiving a connection request addressed to a call filter at the call filter.

15. The bandwidth manager as claimed in claim 11, wherein the bandwidth manager is located on a side of a network closest to the softswitch.

16. The bandwidth manager as claimed in claim 11, wherein the bandwidth manager is located on a side of a network closest to the telephony client.

17. The bandwidth manager as claimed in claim 11, wherein the step of determining if the call connection request is for a high priority call comprises determining that the call request is for a high priority call if the call request is for emergency services.

18. The bandwidth manager as claimed in claim 11, wherein the step of determining if the call connection request is for a high priority call comprises determining that the call request is for a high priority call if the call request is for 911.

19. The bandwidth manager as claimed in claim 11, wherein the step of determining if the call connection request is for a high priority call comprises determining a call origination location and a call destination.

20. The bandwidth manager as claimed in claim 11, wherein the step of determining if the call connection request is for a high priority call comprises determining a call origination location, a call destination and a time of day.
